(19) United States
(12) Patent Application Publication
(10) Pub. No.: US 2010/0005458 A1
(43) Pub. Date: Jan. 7, 2010

(54) METHOD FOR MAKING LINKER PROGRAM

(75) Inventors: YEH CHING CHUNG, HSINCHU (TW); YU HSUN LIN, HSINCHU (TW); MENG JU HSIEH, HSINCHU (TW)

Correspondence Address: WPAT, PC;INTELLECTUAL PROPERTY ATTORNEYS, 2030 MAIN STREET, SUITE 1300, IRVINE, CA, 92614, US

(73) Assignee: NATIONAL TSING HUA UNIVERSITY, HSINCHU (TW)

(21) Appl. No.: 12/167,131

(22) Filed: Jul. 2, 2008

(51) Int. Cl. G06F 9/44

(52) U.S. Cl. 717/162

(57) ABSTRACT

A method for making a linker program comprises the steps of (1) initializing a linker script; (2) selecting functions and sequence of the functions by a user; and (3) sequentially writing the functions to the linker script in accordance with the sequence of the functions. In an embodiment, the method further comprises the step of checking whether all the functions are written to the linker script. If all the functions are written to the file of the linker script, the linker script is completed. If at least one of the functions is not written to the file of the linker script, a user may determine to either complete the file of linker script or again write the functions to the linker script.

### BACKGROUND OF THE INVENTION

(A) Field of the Invention

The present invention relates to a method for making a linker program, e.g., a linker script.

(B) Description of the Related Art

The linker combines input files into a single output file. The output file and each input file are in a special data format known as an object file format. Each file is called an object file. The output file is often called an executable object file. Each object file has, among other things, a list of sections. Sometimes refer to a section in an input file as an input section; similarly, a section in the output file is an output section.

Each section in an object file has a name and a size. Most sections also have an associated block of data, known as the section contents. A section may be marked as loadable, which means that the contents should be loaded into memory when the output file is run. A section with no contents may be allocatable, which means that an area in memory should be set aside, but nothing in particular should be loaded there (in some cases this memory must be zeroed out). A section which is neither loadable nor allocatable typically contains some sort of debugging information.

The linker always uses a linker script. The linker script controls every link. Such a script is written in the linker command language. The main purpose of the linker script is to describe how the sections in the input files should be mapped into the output file, and to control the memory layout of the output file. However, when necessary, the linker script can also direct the linker to perform many other operations, using the linker commands. Linker scripts are text files. A linker script may be a series of commands. Each command is either a keyword, possibly followed by arguments, or an assignment to a symbol.

For linker operation, cache missing may occur while swap in/out. Therefore, the linker script needs to be improved so as to avoid cache missing occurrence.

### SUMMARY OF THE INVENTION

The present invention is directed to providing a method for making a linker program, e.g., linker script, so as to avoid cache missing and improve operation efficiency for applications using the linker program.

The present application proposes a method for making a linker program. The method comprises the steps of (1) initializing a linker script; (2) selecting functions and sequence of the functions by a user; and (3) sequentially writing the functions to the linker script in accordance with the sequence of the functions.

In an embodiment, the method further comprises the step of inputting a file name for the linker script and checking whether the file name is repeated before initializing the linker.

In another embodiment, the method further comprises the step of checking whether all the functions are written to the linker script. If all the functions are written to the file of the linker script, the linker script is completed. If at least one of the functions is not written to the file of the linker script, a user may determine to either complete the file of linker script or again write the functions to the linker script.

Accordingly, the desired functions and the sequence of the functions are recorded in the linker script, so that the related program for applications, e.g., MP3 or MP4, can be operated more efficient, and cache missing caused by swap in/out can be diminished.

### BRIEF DESCRIPTION OF THE DRAWINGS

The objectives and advantages of the present invention will become apparent upon reading the following description and upon reference to the accompanying drawings in which:

FIG. 1 illustrates the method for making a linker program in accordance with the present invention.

### DETAILED DESCRIPTION OF THE INVENTION

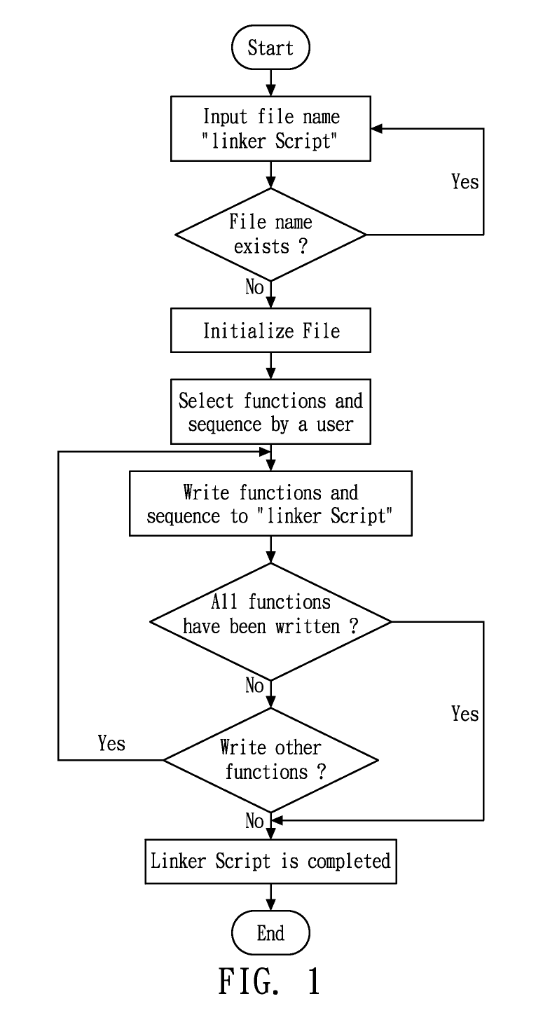

FIG. 1 illustrates a method for making linker program (linker script) in accordance with an embodiment of the present invention. First of all, a making program starts, and a file name for “Linker Script” is determined. If the file name exists already, the user needs to select different file name. If the file name is new, the linker script is initialized by which required information is recorded in the linker script.

Next, according to the user's demand, functions and the sequence of the functions are selected or loaded, thereby avoiding cache missing due to swap in/out. The functions includes:
(1) ReadOnlySections: Control the data for read only and cannot be changed.
(2) Adjust_Data_Segment_Address: Adjust start and end address of data and program.
(3) Exception_Handling: Handle some unexpected situations.
(4) Thread_Local_Storage_Sections: Proceed with access data mechanism when plural programs run concurrently.
(5) Ensure_preinit_array_start_Label: Proceed with confirm mechanism.
(6) Do_small_Data_Sections_Together: Accumulate small and discrete data to save time.
(7) Stabs_Debugging_Sectionsread-only: Auxiliary debugging.

The selected functions are written into the linker script in accordance of the sequence of the functions. If all the selected functions are written in the linker script, the linker script is completed. Otherwise, the user has to determine whether the remaining functions are written in “Linker Script.” If the user would not like to write further functions, the linker script is completed.

Accordingly, because the functions and the sequence are written into the linker script, so that the file can be proceeded faster and cache missing caused by swap in/out can be diminished. As a result, the operation for some video or audio application, e.g., MP3 or MP4, can be proceeded more efficiently, and power consumption can be decreased.

The above-described embodiments of the present invention are intended to be illustrative only. Numerous alternative embodiments may be devised by those skilled in the art without departing from the scope of the following claims.

What is claimed is:

1. A method for making a linker program, comprising the steps of:
initializing a linker script;
selecting functions and sequence of the functions by a user; and
sequentially writing the functions to the linker script in accordance with the sequence of the functions.

2. The method for making a linker program of claim 1, further comprising the step of inputting a file name for the linker script before initializing the linker script.

3. The method for making a linker program of claim 2, further comprising the step of checking whether the file name is repeated after inputting the file name for the linker script.

4. The method for making a linker program of claim 1, further comprising the step of checking whether all the functions are written to the linker script while sequentially writing the functions to the linker script.

5. The method for making a linker program of claim 4, wherein, if all the functions are written to the linker script, the linker script is completed.

6. The method for making a linker program of claim 4, wherein, if at least one of the functions is not written to the linker script, the user determines to either complete the file of linker script or again write the functions to the linker script.
